(19) United States
(12) Patent Application Publication
(10) Pub. No.: US 2011/0296293 A1
(43) Pub. Date: Dec. 1, 2011

(54) END USER VIEWABLE WEB ELEMENT

(76) Inventors: Roop Kumar Bhadury, Eastern Heights (AU); Dev Mayur Zaveri, Robertson (AU)

(21) Appl. No.: 13/117,086

(22) Filed: May 26, 2011

Related U.S. Application Data
(60) Provisional application No. 61/348,557, filed on May 26, 2010.

(51) Int. Cl. G06F 3/14

(52) U.S. Cl. 715/234

(57) ABSTRACT

A user viewable web page element is placed in an unused screen area in a browser. According to one embodiment, the user viewable element is a layered panel in an HTML web page and is displayed on an edge of the web page. The panel is activated by an embedded code in the HTML code of the web page. The panel may be used to display advertisements or other content. The panel provides persistent and seamless content from a page to another page as a user navigates across multiple pages.

### PRIORITY

This application claims the benefit of U.S. provisional application 61/348,557, filed on May 26, 2010, under 35 USC §119(e), the entire contents of which are incorporated herein by reference.

### FIELD

The field of the invention relates generally to computer systems. In particular, the present method and system is directed to generating a user viewable element within a screen area.

### BACKGROUND

Historically, applications that serve web page advertisements to users are downloaded and included as data within a web page. This method adds extra data to load onto a user device causing delays and adding undesirable “weight” to the web page. Moreover, this type of application can be very limited in interactivity and functionality.

In online advertising the user is often neglected. The current trend is to deliver numerous banner ads, text based ads, rich content and the like without necessarily attempting to understand what the end user actually wants.

This results in ads trying to force or deceive the user into clicking on something that the user may not have normally clicked on. Users have responded to these tactics by practically ignoring online ads, with global CTR (Click-through rates) hovering around 0.10%.

Therefore, what is needed and what the present application addresses is an advertisement and content panel that is itself an interactive web page that reduces the host web page “weight” while allowing increased interactivity and functionality.

### SUMMARY

A system and method is disclosed comprising a user viewable element in an unused screen area in a browser. In an embodiment, the user viewable element is a layered panel in an HTML host web page wherein the layered panel is displayed on an edge of the host web page. The panel is activated by an embedded code in the HTML host web page wherein the layered panel comprises an edge panel displayed on an edge of the host web page. The panel is an interactive web page.

In an embodiment, the user viewable element is a layered panel that sits on available, unused screen real estate in a browser. The panel may position itself to the right or left in extra blank real estate on a web page, and can also use the top or the bottom edges of the page. This panel also displays on web pages with fluid design by horizontally or vertically resizing the page to accommodate the panel.

In an embodiment, a panel is delivered to the user's browser when a web page with a panel code loads. The panel code detects the available screen resolution on the user's browser and stays open if the panel can reside in an existing blank space. If there is inadequate space available within the browser, the panel may auto-collapse or resizes. The user can un-collapse the panel by clicking on an open/close trigger button built into the panel.

In an embodiment, the panel provides simultaneous, seamless, and non-intrusive advertising to the user. The panel delivers non-commercial content and applications to the panel.

The above and other preferred features, including various novel details of implementation and combination of elements, will now be more particularly described with reference to the accompanying drawings and pointed out in the claims. It will be understood that the particular methods and circuits described herein are shown by way of illustration only and not as limitations. As will be understood by those skilled in the art, the principles and features described herein may be employed in various and numerous embodiments without departing from the scope of the invention.

### BRIEF DESCRIPTION OF THE DRAWINGS

The accompanying drawings, which are included as part of the present specification, illustrate a presently preferred embodiment and together with the general description given above and the detailed description of a preferred embodiment given below serve to explain and teach the principles of the present invention.

FIG. 1 illustrates an exemplary flow diagram of a process of inserting a panel into a web page of a website, according to an embodiment of the invention;

FIG. 2 illustrates an exemplary flow diagram of a process of measuring user exposure to panel content, according to an embodiment of the invention;

FIG. 3 illustrates an exemplary flow diagram of a process of managing exposure to panel content across multiple web pages, according to an embodiment of the invention.

FIG. 4 illustrates an exemplary user viewable element, according to an embodiment;

FIG. 5 illustrates a site-type user viewable element, according to one embodiment; and

FIG. 6 illustrates a page-type user viewable element, according to one embodiment.

It should be noted that the figures are not necessarily drawn to scale and that elements of similar structures or functions are generally represented by like reference numerals for illustrative purposes throughout the figures. It also should be noted that the figures are only intended to facilitate the description of the various embodiments described herein. The figures do not describe every aspect of the teachings described herein and do not limit the scope of the claims.

### DETAILED DESCRIPTION OF THE PREFERRED EMBODIMENTS

The present application is related to U.S. patent application entitled “Advertising and Mobile Site Builder” by Roop Kumar Bhadbury, Mark Brown, Derek McDonald, and Dev Mayur Zaveri, filed on May 26, 2011; U.S. patent application entitled “Content and Application Serving Mechanism” by Roop Kumar Bhadbury, Derek McDonald, and Dev Mayur Zaveri, filed on May 26, 2011; and U.S. patent application entitled “User Account Linking” by Roop Kumar Bhadbury, Derek McDonald, and Dev Mayur Zaveri, filed on May 26, 2011, the entire contents of which are incorporated herein by reference.

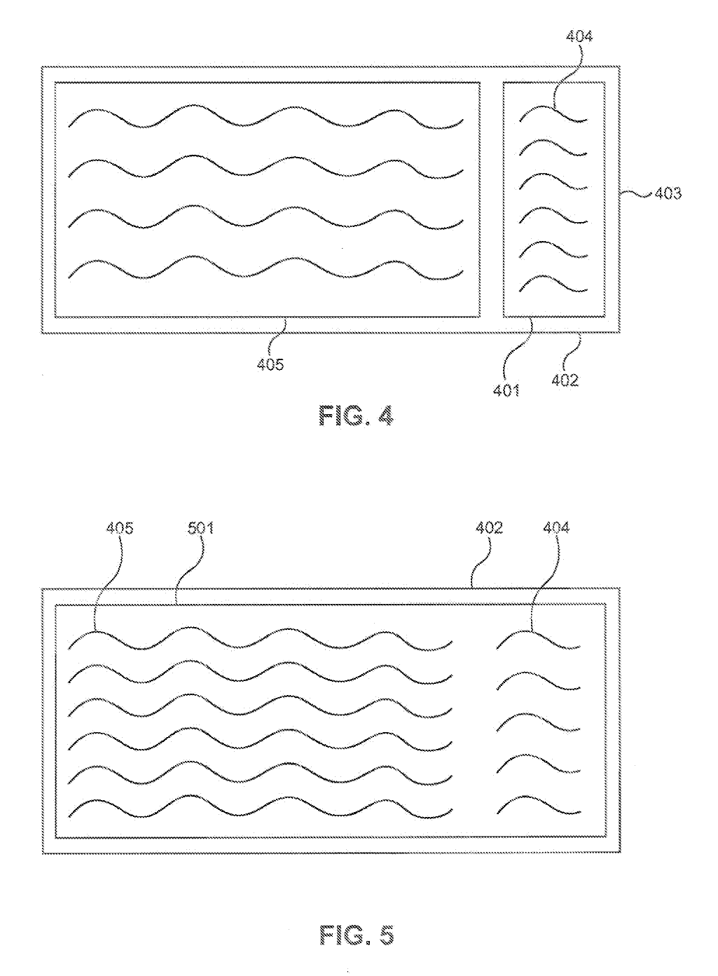

A system and method for presenting content to a web page user is described, comprising a user viewable element placed in an unused screen area in a web browser. In an embodiment, turning to FIG. 4, the user viewable element is a layered panel 401 displayed in a host web page 402. The web page 402 may be implemented in a variety of formats, including HTML, XML, and other similar languages used to implement web pages. The panel 401 displays panel content 404, such as an advertisement, to the user, along with user-requested content 405. Alternatively, the panel 401 can display non-commercial content, or applications, to the user. In one preferred embodiment, the panel 401 is displayed on an edge 403 of the web page 402. The panel 401 is activated by an embedded code in the web page. In an embodiment, the code of the panel 401 is inserted as a small snippet of code in the HEAD section of the HTML code of the web page 402. This embedded code instructs the user's browser to retrieve the panel content from a server of the panel content host. The panel is lightweight because there is nothing to be installed on the web servers of the publisher, and there is nothing, other than the actual panel content, to be downloaded or installed in the browser of the end user.

Once the snippet of the code is inserted, the panel may be enabled as a part of the web page 402 according to at least two alternative embodiments, discussed below. The panel content host can determine which method to invoke by analyzing the URL for the requested page. This avoids the need to have different code snippets embedded in the page for each method. The method of each embodiment ultimately loads the content of the panel 401 inside a frame, referred to as an “iframe.” An iframe is an inline frame of an HTML document that contains another document. The methods further described below define the manner in which information is displayed within the panel in the browser of the end user.

In a first embodiment, shown in FIG. 5, a site-type panel 501 contains the entire web page content downloaded by the user, including both the user-requested content 405 and the panel content 404. The whole web page is contained inside an iframe within the user's browser. Unlike a traditional implementation of a displayed browser page, where the iframe sits within the displayed page, in this embodiment all of the web page content 405 is recreated inside the iframe. The panel content 404 is also created within the same iframe. This creates a scenario wherein the user can navigate multiple web pages within the site-type panel 501 without needing to reload his browser when he/she changes pages. Since the entire web page content 405 is contained within the site-type panel 501, when the user navigates to multiple web pages within the web site, the user remains within the site-type panel 501, and the same panel content 404 remains visible on the user's browser. This presents the user with a persistent presence and viewing experience, particularly as regards the panel content 404.

In this embodiment, the positioning of the iframe containing the web page content 405 and the site-type panel 501 is specified by the publisher of the web page content 405. Further browsing within the website can now occur without the panel 501 having to be reloaded. The publisher of the panel 501 can also select web pages to embed a particular panel 501, or to display particular panel content 404 on the panel 501. For instance, a publisher advertising a particular technology may only want the panel 501 or content 404 displayed on websites related to that technology of interest. Thus, the publisher will select the panel type and/or content to match the website type.

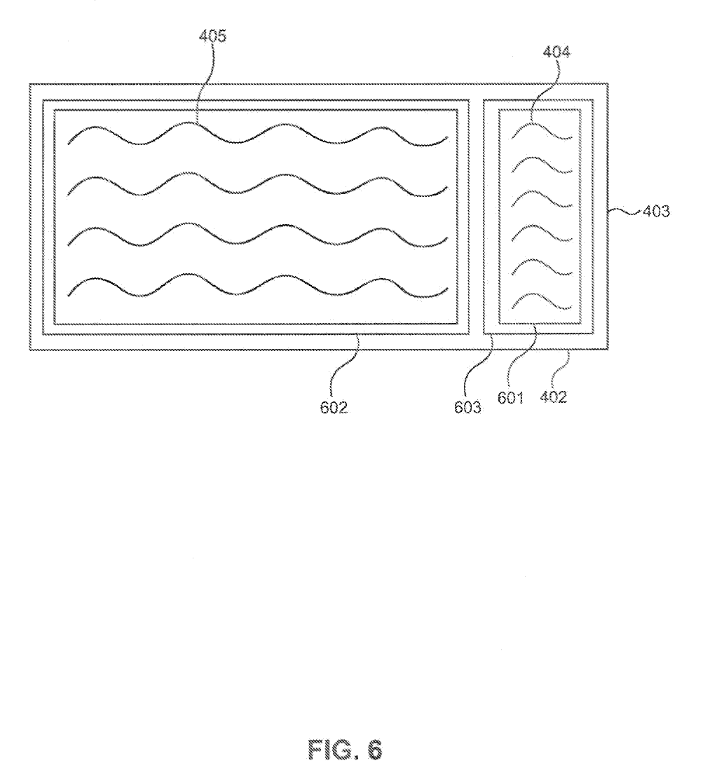

In a second embodiment, shown in FIG. 6, a page-type panel 601 contains just the panel content 405, but not the web page content 405. When the web page 402 loads, and the panel code is invoked, two containers 602 and 603 are introduced. Each container 602, 603 is, in an embodiment, a generic block container in an HTML page. The web page content 405 is pushed to the first container 602 and the page-type panel 601 is pushed to the second container 603. Alternatively, the page-type panel 601 and container 602 could be implemented as a single construct, if an appropriate programming language used to implement the page permits. The positioning of the containers 602 and 603 for the web site content 405 and page-type panel 601 are specified by the publisher of the web site content. In this embodiment, the panel code is placed on every page of the publisher website on which the panel 601 is displayed.

This embodiment allows a page-level control in the display of ads and content. This can be leveraged by web publishers to set the flow of content across similarly tagged pages. Separate panel code snippets may be inserted into different pages to display content based on different sets of advertising and content preferences. In one embodiment, session management across panels on a website occurs with the same panel code inserted on multiple pages containing the panels. When the user navigates from one page to the other, the content in one panel from one page is carried to the next panel in the new page, allowing interrupted advertising as well as regular panel content to stay persistent across pages.

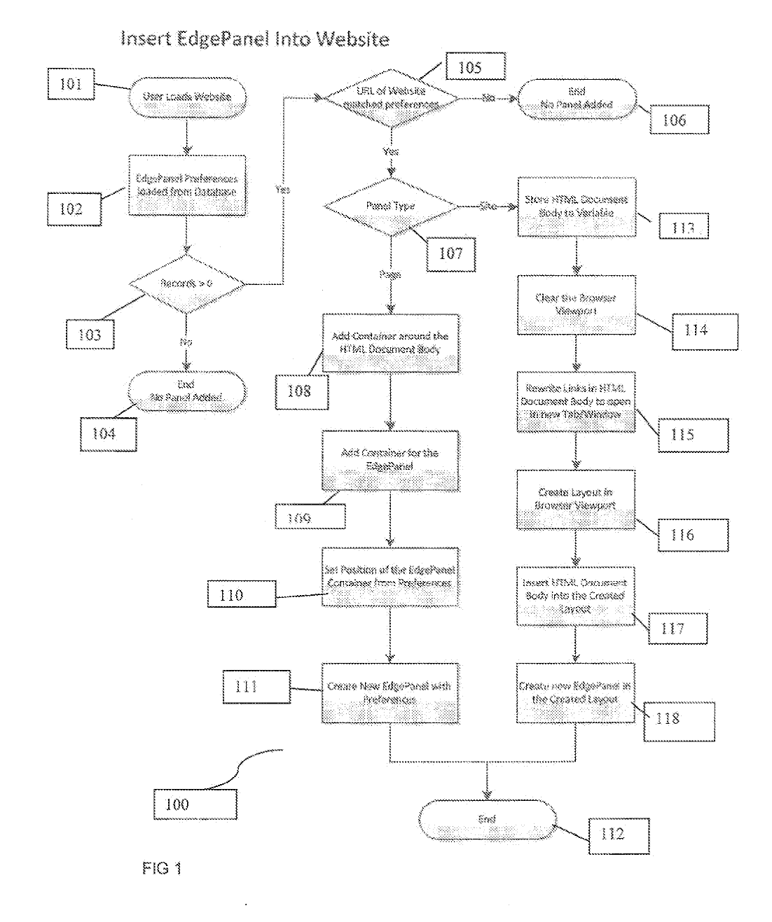

According to a preferred embodiment, a method of inserting the panel 501, 602, or 603 into the web page 402 is illustrated in FIG. 1. Referring to FIG. 1 and flowchart 100, at step 101, a user types in a URL in the address bar of a web browser and presses Enter. As the web page loads, the panel code is invoked. When the web page loads, at step 102 preferences for the panel are loaded from database of the panel publisher or a server of the panel content host. If a record exists in the database 102, then at step 103, a records counter is incremented to a number greater than 0. If the records counter is 0, then there is no panel to be added to the web page, and the method terminates at step 104. If the records counter is greater than 0, the panel preferences are matched to the URL of the website, at step 105. If the panel preferences do not match the URL of the website, the requested website does not have any associated panel content 404 to be associated or displayed, so no panel is inserted and the method terminates at step 106. If, however, one of the panel preferences matches the URL of the website, the associated panel content 404 is displayed. At step 107, a determination is made as to whether the panel is a page-type panel 603 or a site type panel 501. For a site-type panel 501, at step 113 the web page content 405 (e.g. the HTML document body for the page requested by the user) is stored temporarily in the panel publisher's database, and at step 114 the user's browser viewport is cleared. The links in the web page content 405 are rewritten to open in a new tab or window, at step 115. Alternatively, any external links are modified so that clicking on an external link opens the external site and removes the panel 501 from the user's browser. At step 116, a new layout is created in the browser viewport, for containing the page-type panel 501. At step 117, the web page content 405 is inserted into the created layout, and at step 118 the panel content 404 is created in the created layout. The panel content 404 and the web page content 405 are then displayed within the web page 402, and the process is complete at step 112.

For a page-type panel 601, at step 107, a container 602 is added around the web page content 405, at step 108, and a container 603 is added around the page-type panel 601, at steps 108 & 109. After the containers 602, 603 are added, at step 110 the position of the container 603, relative to the container 602, is determined from the panel preferences that were loaded in step 102. Finally, the page-type panel 601 is created according to the panel preferences, along with the web page content 405 in the container 602, at step 111, and displayed at step 112.

When the user loads a web page 402 containing a panel code for the panel 501 or 603, the system of an embodiment checks the resolution of the user's browser screen and determines whether the user's screen is capable of displaying the panel 501 or 603. If the user's screen or viewport resolution is less than a pre-determined to be a minimum resolution to display the panel 501, 603, the panel 501, 603 are not rendered and the user's web. If there is inadequate screen resolution within the browser, then the panel 501, 601 auto-collapses or resizes itself. The users can un-collapse the panel 501, 601 by clicking on an open/close trigger button built into the panel 501, 601.

If the resolution is sufficient, the containers/panels 501, 602, 603 are rendered dynamically and inserted into the page, after the container is created. The system of an embodiment checks to see if the pixel width of the website is provided by the user. If pixel width is provided and there is an enough screen space, the system inserts a container without reducing the width of the web site content 405. For example, if (screen_widt−website_width)>2×panel_width+˜20 pixels), then it is considered that there is an enough screen space.

If, however, there is not enough space to insert the containers/panels without reducing the width of the web page, the system checks to see if the panel content 404 can fit on the screen. For example, if (screen_width−website_width)>panel_width, the panel can fit if the website is moved. If there is a sufficient space, the width of the container 602 or the website content 405 is reduced to permit the panel content 404 to fit on the web page. If the pixel width of the website is not provided, then the system reduces the website width to create a space for the panel content 404, as long as the screen resolution is higher than the pre-determined minimum resolution for the panel 501, 601.

The system of an embodiment also allows for specific inclusions or exclusions of panel content 404 to be set up, where the panel 501, 601 displays or not display depending on setting provided by the publisher/client. These inclusions and exclusions act as another layer of decisions around the rendering of the panel 501, 601, in addition to screen resolution. For example, where a user browses a web page containing the panel code, the browser URL is matched with the panel preferences, as discussed above at step 105 of FIG. 1. If there is a match, for example if the browser URL is http://www.google.com/intl/en/ads/, and this URL is found in a list of URLs in the panel preferences, then the panel 501, 601 associated to this specific URL is rendered. If there is no match, however, the system of an embodiment will check the higher-level URLs http://www.google.com/intl/en/ and http://www.google.com/intl and http://www.google.com to see if any of them matches the panel preferences. If there is a match, the panel 501, 601 associated with these higher-level URLs is rendered.

According to one embodiment, the panel 501 or 601 in the browser defines, controls and measures the end user experience. Website publishers specify advertising/content in the panel 501, 601. This is handled in the panel 501, 601, where an ad/content impression of a certain type is displayed only on a panel that accepts that type. Referring to FIG. 1, once the user loads a web page at step 101, panel preferences are loaded from the publisher's database at step 102, and the URL of the website is matched to the publisher's preferences for the type of ad/content that gets displayed in the panel, at step 105. This approach of type tagging allows for a level of content filtering where, for example, premium ads can be displayed separately from regular ads in the same panel.

According to one embodiment, an advertisement or panel content 404 is displayed for different durations in the panels 501, 601. The panel 501, 601 measures the duration for which the advertisement or content 404 was displayed using a counter that runs for the predetermined duration. Once the ad exposure of, for example, Type A is completed, the panel 501, 601 calls for another ad of the same type to be displayed.

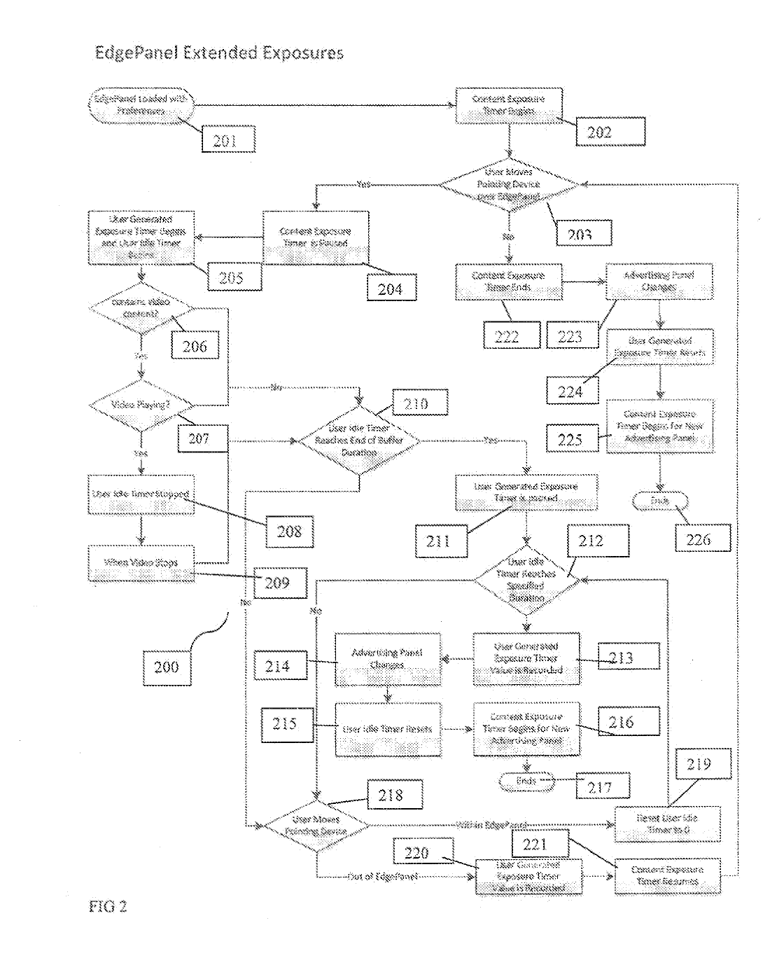

Referring to flowchart 200 in FIG. 2, the panel 501, 601 is loaded with the publisher's preferences, at step 201, and a content exposure timer begins counting exposure times, at step 202. At step 203, the system checks to see whether the user has focused his attention on the panel 501, 601, for example by moving a pointing device such as a mouse over the panel 501, 601. If so, the content exposure timer is paused at step 204, and two additional timers are start, for example, a user generated exposure timer and a user idle timer, at step 205. If the panel contains video content, at step 206, and a video is actually playing in the panel, at step 207, the user idle timer is stopped at step 208, until the video has stopped playing at step 209, whereupon the user idle timer is resumed. Once the video stops, or if no video content exists, then the system checks if the user idle timer has reached the end of the publisher's predetermined buffer duration for a decision as to whether or not the user has ceased viewing the ad/content in the panel 501, 601, at step 210. If the user idle timer has reached the end of the predetermined buffer duration, the user generated exposure timer is paused at step 211. At step 212, the user idle timer is checked to see if it has reached its specified duration. If the specified duration has been reached, at step 213 the exposure timer value is recorded so that the publisher can accumulate data on the user's interest level of the ad/content. The panel content 404 in the panel 501, 601 changes at step 214, to display new content. At step 215, the user idle timer is reset. At step 216, the content exposure timer begins for a new panel (i.e. control returns to step 202) and at step 217 the current timer session ends.

If at step 210 the user idle timer has not reached the end of the predetermined buffer duration, or at step 212 the user idle timer has not reached the specified duration, at step 218 the system checks to see if the user has changed his focus, for example by moving the pointing device. If the user has moved the pointing device, but is still within the panel 501, 601, then the user has presumably not changed his focus, and is also no longer idle. The user idle timer is reset at step 219, and control passes to step 212 for processing as above. If, however, the user has moved the pointing device outside the panel 501, 601 or it is detected that the user presumably has changed his/her focus away from the panel content 404, the user exposure timer value is recorded so that the publisher can accumulate data on the interest level of the ad/content, at step 220. At step 221, the user content exposure timer resumes, and control passes to step 203 for further processing.

If at step 203 the system determines that the user's focus has moved away from the panel content 404, for example the user has moved the pointing device away from the panel 501, 601, then at step 222, the content exposure timer ends. At step 223, the panel content 404 changes to display new ad/content. At step 224, the user generated exposure timer is reset, and at step 225 a new content exposure timer for the new content 404 displayed in the panel 501, 601 is begun (returning control to step 202), and the current session ends at step 226.

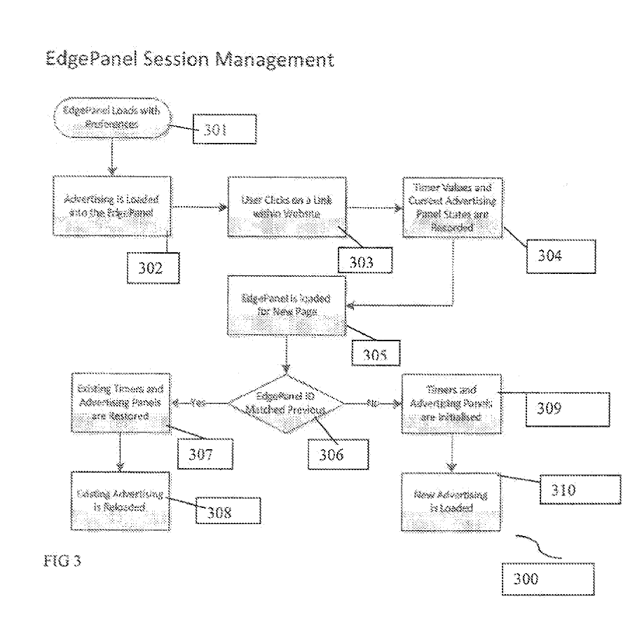

The panel 501, 601 also detects active or inactive viewport status, pausing or continuing panel timers accordingly. Advertisement or content serving is paused when the panel is inactive. There are two inactive state triggers for the panel 501, 601, leading to the same timer outcome. The first inactive state occurs when the panel and the web page are on an inactive tab within a browser. This may occur as users often open multiple tabs during a browsing session. The second inactive state occurs when the panel is a part of an inactive window, residing behind another browser or application window. Additionally, other ways of detecting inactive viewports are possible. For example, if a user's machine is inactive, because for example the user has stepped away from his computer, or cause his computer to enter a sleep mode, this inactivity is detected and treated as above. FIG. 3 illustrates a method for managing a user's navigation through multiple web pages. The panel 501, 601 loads with the publisher's preferences, at step 301, and the publisher's advertising content (e.g. content 404) is loaded into the panel 501, 601 at step 302. When a user clicks on a link within the website, at step 303, the timer values as described above and the current state of the panel 501, 601 are recorded, at step 304. A new page is loaded and the corresponding panel 501, 601 is retrieved for this page, as discussed above, at step 305. The system determines if an identifier for the new panel 501, 601 matches that of the previous panel 501, 601, at step 306. If there is a match, the existing timers and panel 501, 601 are restored at step 307, and the advertisement (i.e. content 404) is reloaded at step 308, providing a continuous display of the panel 501, 601 and the content 404 from page to page. An example of a continuous display may include a video which would seamlessly continue in progression from one page to the next page. If the panel identifier does not match the previous panel 501, 601 at step 306, at step 309 the timers and panel 501, 601 are initialized to begin a new session, and a new panel 501, 601, containing new content 404, is loaded at step 310.

It is understood that the embodiments described herein are for the purpose of elucidation and should not be considered limiting the subject matter of the disclosure. Various modifications, uses, substitutions, combinations, improvements, methods of productions without departing from the scope or spirit of the appended claims would be evident to a person skilled in the art.

We claim:

1. A panel for displaying online content, the panel comprising:
a first area for displaying user-requested content; and
a second area for displaying provided content,
wherein the panel is configured to preserve the provided content while simultaneously changing the user-requested content, according to a request from the user for new user-requested content.

2. The panel of claim 1, wherein the first area contains an entire web page requested by the user.

3. The panel of claim 1, wherein the provided content is presented seamlessly as the user-requested content changes.

4. The panel of claim 3, wherein the provided content comprises video content.

5. A method of providing online content to a user comprising:
receiving a request for online content from the user;
receiving panel configuration information corresponding to the request;
selecting a panel type based on the configuration information;
generating a panel containing provided content according to the selected panel type; and
presenting the online content and the generated panel to the user.

6. The method of claim 5, wherein the panel type comprises a page-type panel.

7. The method of claim 6, wherein the panelt type comprises a site-type panel.

8. The method of claim 7, wherein generating the panel comprises loading the online content requested by the user into a first area within the panel, and loading the provided content into a second area within the panel, wherein the second area is configured to preserve the provided content and the first area is configured to present new user-requested content in response to requests from the user.

9. The method of claim 6, wherein generating the panel comprises:
detecting a size of a display that will display the online content requested by the user;
comparing the size to a minimum allowable size value;
if the size is below the minimum allowable size value, not generating the panel;
if the size is above the minimum allowable size value, presenting the online content and the panel to the user, for display on the display.

10. The method of claim 9, wherein presenting the online content and the panel comprises presenting a first location on the display for the online content and a second location on the display for the panel, such that both the online content and the panel will be visible when displayed on the display.

11. The method of claim 10, wherein presenting the first location comprises moving the online content from a prior location.

12. The method of claim 10, wherein presenting the first location comprises resizing a size of the online content.
